(19) United States
(12) Patent Application Publication
(10) Pub. No.: US 2022/0193585 A1
(43) Pub. Date: Jun. 23, 2022

(54) FILTER ELEMENT, FILTER MEDIA, AND METHODS OF MAKING SAME

(71) Applicant: Facet (Oklahoma) LLC, Tulsa, OK (US)

(72) Inventors: Ronald McDowell, Tulsa, OK (US); Donald Dongho Cho, Carrollton, TX (US); Andrew Dye, Aledo, TX (US); Andrew Charles Thompson, Owasso, OK (US)

(21) Appl. No.: 17/558,009

(22) Filed: Dec. 21, 2021

Related U.S. Application Data
(60) Provisional application No. 63/129,257, filed on Dec. 22, 2020.

(51) Int. Cl. B01D 39/16; D04H 1/60; D04H 1/587; D06M 13/53; D06M 13/148; B01D 46/00

(52) U.S. Cl. CPC B01D 39/163; D04H 1/60; D04H 1/587; D06M 13/53; B01D 2275/10; B01D 46/0004; D10B 2401/021; D10B 2505/04; D06M 13/148

(57) ABSTRACT

A filter element including a filter media and methods for making the same are provided. The filter element includes a support core surrounded by a tubular ring of filter media. A first end of the tubular ring of filter media is coupled to a first end cap and a second end of the tubular ring of filter media coupled to a second end cap. The tubular ring of filter media includes a carrier media layer, a coarse filter media layer, a fine filtration media layer, a water-capturing media layer, and an outer wrap.

### CROSS-REFERENCE TO RELATED APPLICATION

This application claims the benefit of and priority to U.S. Provisional Application No. 63/129,257, filed Dec. 22, 2020, the content of which is hereby incorporated by reference.

### FIELD OF THE DISCLOSURE

This disclosure generally relates to a filter element, filter media, and a method of making same. An improved filter element employs a layer of filter media including a thermoplastic resin for effectively removing free-water and other contaminants from liquid hydrocarbon fuels and other organic liquids, the filter element acting as a monitor to completely shut off liquid flow when excessive free-water contaminant is present in the liquid hydrocarbon fuel and the filter element has reached its capacity.

### BACKGROUND

The most commonly used filter materials to remove free-water from liquid hydrocarbon fuels are hydrophobic filter media (repels water) and coalescing filter media (water adheres to outer surface). The materials used almost exclusively in prior art filters are cellulose fibrous paper, acrylics, synthetic polymers, and fiberglass, which may be treated with an inert organic resin binder such as phenol-formaldehyde or the like. None of these filter materials are very effective for removing free-water from organic liquids by absorption or adsorption.

Rather, both materials act to coalesce the small drops or globules of water into large drops thus causing a separation into two liquid phases, provided the organic liquid being filtered is not contaminated with a critical amount of emulsifying agents or surfactants. Unless the filtering system is equipped with a hydrophobic separator the effluent stream can readily be re-contaminated from the coalesced water phase. Additional layers of the filter material do help to reduce the amount of remaining free-water. However, the organic liquid filtered through such materials in many cases still contains an appreciable amount of free-water and other contaminants.

It is to be particularly noted that when free-water is removed by either hydrophobic action or coalescence, the water so removed remains intact as a distinct entity and in its original liquid form.

A super-absorbent filter resin was identified as a more effective way to remove free-water from liquid hydrocarbon fuels. The most commonly used version of the super-absorbent filter resin is a sodium polyacrylate. The super-absorbent filter resin is made from a granular powder that can remove particulate solid contaminants, but primarily is for its true absorption qualities where it can substantially remove almost all of the free-water that passes through the filter resin. The super-absorbent filter resin, which may be in solid granular powder form or staple fiber forms, has a strong affinity for water.

Further, as water is absorbed by the super-absorbent polymer it gradually changes its physical construction or form, which allows the super-absorbent polymer to absorb much more water relative to the original weight of the super-absorbent polymer; still yet even when the super-absorbent polymer becomes saturated with water it will continue to allow the passage of hydrocarbon fuels and other organic liquids.

Then when the amount of excessive free-water penetrating the filter material made from the super-absorbent polymer reaches its saturation level the super-absorbent polymer expands into the void space within the filter, thus blocking all flow paths which allow the passage of hydrocarbon fuels and other organic liquids. Thus, the filter material made from the super-absorbent polymer also provides the additional benefit of shutting off the passage or flow of the liquid being filtered when excess free-water contaminant is present in the filter indicating to the user that the filter material has reached its full capacity for filtering free-water and needs to be replaced.

While the above filter material formed from the super-absorbent polymer has many advantages it is not without its disadvantages. Namely, in use, the filter material made from the super-absorbent polymer breaks down when the reaction with free-water occurs. The broken-down super-absorbent polymer can break away and contaminate the liquid hydrocarbon fuel as it passes through the filter material. The broken down super-absorbent polymer particles then act as a contaminant of the liquid hydrocarbon fuel that the filter material is being used to purify. Therefore, there is a need for a filter element and filter media that can effectively remove free-water from filter liquid carbon fuels and does not break down to contaminate the liquid hydrocarbon fuel being filtered therethrough.

The disclosure provides such a filter element and filter media. These and other advantages of the disclosure, as well as additional inventive features, will be apparent from the description of the embodiments provided herein.

### SUMMARY

In one aspect, the disclosure provides a filter element comprising a support core surrounded by a tubular ring of filter media. A first end of the tubular ring of filter media is coupled to a first end cap and a second end of the tubular ring of filter media is coupled to a second end cap. The tubular ring of filter media includes a carrier media layer, a coarse filter media layer, a fine filtration media layer, a water-capturing media layer, and optionally another coarse filter media layer, and an outer wrap.

According to another aspect, the carrier media layer is a scrim carrier.

According to still yet another aspect, the coarse filter media layer is a hydrophobic screen.

According to still yet another aspect, the first fine filtration media layer is composed of a nonwoven material.

According to another aspect, the outer wrap is made from a synthetic or organic material.

In yet another aspect, the water-capturing media layer includes bonding a polyethylene oxide (“PEO”) within a three-dimensional array of fibers.

In yet another aspect, the water-capturing media layer includes fibers comprised of PEO within a three-dimensional array of fibers.

According to yet another aspect, the first end cap is one of an open end cap and a closed end cap.

According to still yet another aspect, the second end cap is one of a closed end cap and an open end cap.

According to another aspect the present disclosure provides a filter assembly comprising a filter housing including a filter vessel. The filter vessel includes an inlet and an outlet and a partition including at least one opening located therebetween and a filter element. The filter element includes a support core surrounded by a tubular ring of filter media. A first end of the tubular ring of filter media is coupled to a first end cap and a second end of the tubular ring of filter media is coupled to a second end cap where the first end cap is couplable to the opening in the partition of the filter vessel. The tubular ring of filter media includes a carrier media layer, a coarse filter media layer, a fine filtration media layer, a water-capturing media layer, optionally another coarse filter media layer, and an outer wrap.

According to yet another aspect, the carrier media layer is a scrim carrier.

According to another aspect, the coarse filter media layer is a hydrophobic screen.

According to yet another aspect, the first fine filtration media layer is composed of a nonwoven material.

According to still yet another aspect, the outer wrap is made from a synthetic or organic material.

According to yet another aspect, the water-capturing media layer includes bonding a PEO within a three-dimensional array of fibers.

In yet another aspect, the water-capturing media layer includes fibers comprised of PEO within a three-dimensional array of fibers.

According to still yet another aspect, the first end cap is an open end cap.

According to still yet another aspect the second end cap is a closed end cap.

According to another aspect of the present disclosure a method of making a layer of water-capturing filter media is provided. The method comprises selecting a first fiber and a second fiber and bonding the first fiber to the second fiber to form a 3D fiber matrix. The method further comprises applying a PEO to the 3D fiber matrix and applying heat and pressure to the PEO and the 3D fiber matrix until the PEO forms a physical or chemical bond to the 3D fiber matrix.

According to still yet another aspect the method for making a layer of water-capturing filter media, the first fiber or the second fiber selected to make the 3D fiber matrix are one of an acetate fiber, a polyester fiber, a nylon fiber or a rayon fiber.

According to still yet another aspect the method for making a layer of water-capturing filter media, the PEO applied to the 3D fiber matrix is a powdered PEO.

According to still yet another aspect the method for making a layer of water-capturing filter media, the process of applying heat and pressure to the PEO and the 3D fiber matrix includes sintering the PEO and the 3D fiber matrix until the PEO is physically or chemically bonded to the 3D fiber matrix.

In yet another aspect, the water-capturing media layer include fibers comprised of PEO within a three-dimensional array of fibers.

Other aspects, objectives and advantages of the embodiments will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present disclosure and, together with the description, serve to explain the principles of the embodiments. In the drawings:

FIG. 1 is a side cross-sectional view of a filter apparatus with a filter element installed within the filter apparatus according to one aspect of the present disclosure;

FIG. 2A is a side view of a filter element installed in the filter apparatus illustrated in FIG. 1;

FIG. 2B is a cross-sectional view of the filter element illustrated in FIG. 2A;

FIG. 3A is a bottom perspective view of a closed end cap of the filter element illustrated in FIGS. 2A and 2B;

FIG. 3B is a top perspective view of the closed end cap illustrated in FIG. 3A;

FIG. 4A is a top perspective view of the open end cap of the filter element illustrated in FIGS. 2A and 2B;

FIG. 4B is a top perspective view of the open end cap illustrated in FIG. 4A illustrating a projection portion of the open end cap removed from a collar portion of the open end cap;

FIG. 5A is a side view of a support core of the filter element illustrated in FIGS. 2A and 2B;

FIG. 5B is a top view of the support core illustrated in FIG. 5A;

FIG. 6 is a partial cross-sectional perspective view of the filter element illustrated in FIGS. 2A and 2B further illustrating the various layers of a tubular roll of filter media of the filter element illustrated in FIGS. 2A and 2B;

FIG. 7 is front cross-sectional view of a tubular roll of filter media of the filter element illustrated in FIGS. 2A and 2B; and

FIG. 8 is a side view illustrating a method for manufacturing the filter element illustrated in FIGS. 2A and 2B and further illustrating the different layers of the tubular roll of filter media included in the filter element.

While the disclosure will be described in connection with certain preferred embodiments, there is no intent to limit it to those embodiments. On the contrary, the intent is to cover all alternatives, modifications and equivalents as included within the spirit and scope of the disclosure as defined by the appended claims.

### DETAILED DESCRIPTION OF THE DISCLOSURE

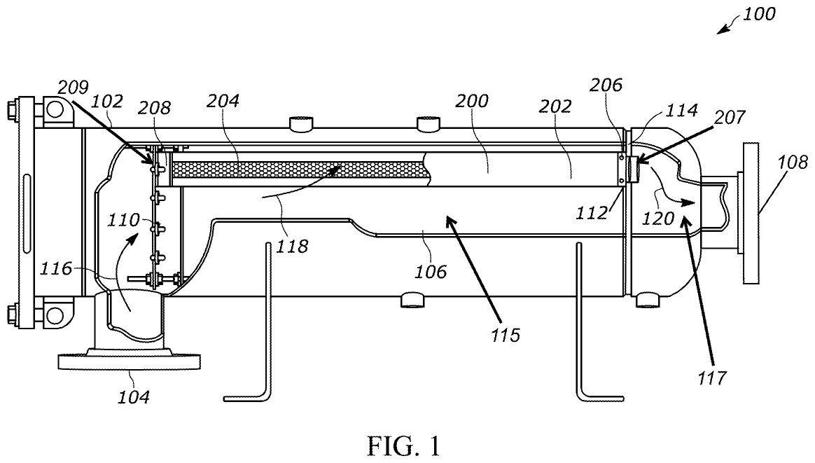

FIG. 1 illustrates a filter assembly 100 according to one aspect of the present disclosure. As illustrated, the filter assembly 100 includes a filter vessel 102 and a filter element 200 that is positioned within the filter vessel 102. The filter element 200 has a support core 204 and a tubular ring of filter media 202 that surrounds the support core 204. Located at a first end 207 of the filter element 200 is an open end cap 206 and located at a second end 209 of the filter element 200 is a closed end cap 208.

The open end cap 206 is coupled to a first end of the tubular ring of filter media 202 and the closed end cap 208 is coupled to the opposing side of the tubular ring of filter media 202, such that a waterproof seal is formed between the tubular ring of filter media 202 and the open end cap 206 and the closed end cap 208.

As will be understood, the open end cap 206 and the closed end cap 208 can be coupled to the tubular ring of filter media 202 by any means generally known in the art, such as, but not limited to any adhesive, epoxy or resin generally known in the art.

Next, the filter vessel 102 includes an inlet 104 that opens into an internal cavity 106 before terminating near an outlet 108 of the filter vessel 102. As illustrated, the filter vessel 102 also includes a bracket 110 designed to receive and support the second end 209 of the filter element 200 while an opening 112 in a partition 114 of the filter vessel 102 is designed to receive and support the first end 207 of the filter element 200. The partition 114 also acts to separate the internal cavity 106 into a dirty fluid plenum 115 and a filtered fluid plenum 117.

According to another aspect of the present disclosure the filter vessel 102 will be capable of accommodating any number of filter elements 200 governed by the principles of the present disclosure desired by a user.

As will also be understood, the filter elements 200 governed by the principles of the present disclosure can be any shape or size required to fit within a specific filter vessel 102 being used by a user.

In use, the dirty fluid to be filtered by the filter element 200 flows 116 into the inlet 104 of the filter vessel 102 where it will enter the dirty fluid plenum 115. The dirty fluid to be filtered will collect in the internal cavity 106 of the filter vessel 102 until sufficient pressure is reached within the internal cavity 102 to force the dirty fluid to flow 118 through the tubular ring of filter media 202 of the filter element 200.

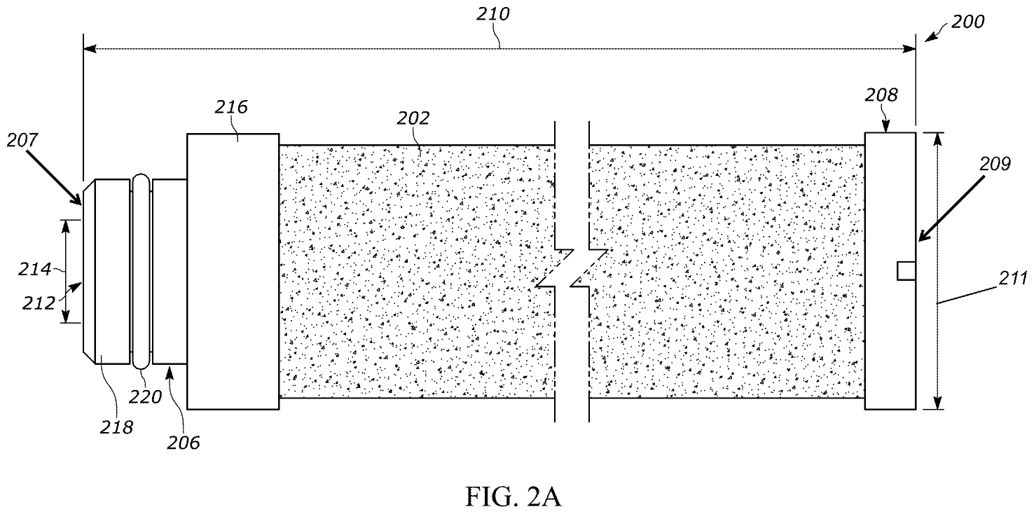

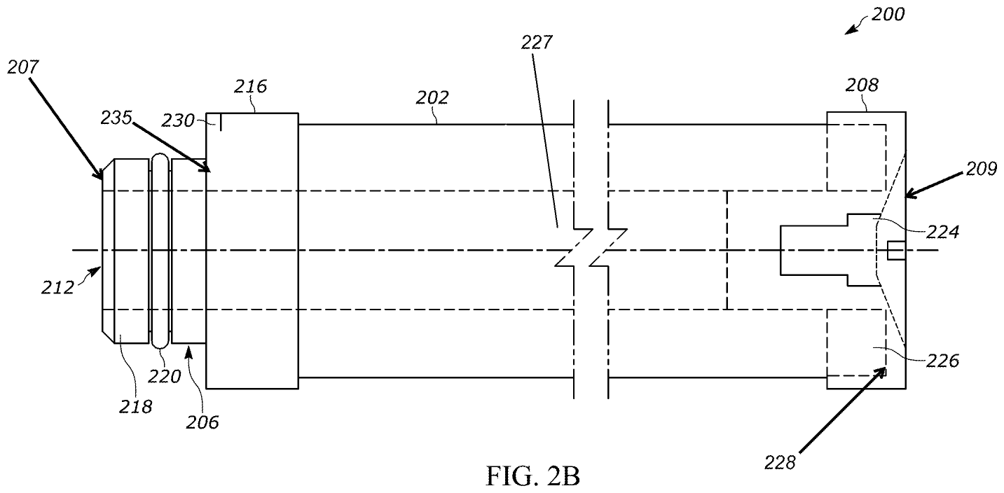

As will be understood, as the dirty fluid to be filtered flows 118 through the tubular ring of filter media 202 the dirty fluid will be filtered of contaminants. The now filtered fluid will collect in the internal cavity 227 (see FIG. 2B) of the filter element 202 before it will flow 120 through the open end cap 206 of the filter element 200 that is coupled to the opening 112 in the partition 114 of the filter vessel 102. After the filtered fluid escapes the open end cap 206 of the filter element 200 it will collect in the filtered fluid plenum 117 of the filter vessel 102 where the now filtered fluid can be collected for use by a user.

In the illustrated embodiment, the dirty fluid to be filtered flows 118 radially through the filter element 200 in an outside to inside manner 118. However, it is envisioned that a filter element 200 governed by the principles of the present disclosure could also be designed to filter dirty fluid that radially flows through the filter element 200 in an to outside manner or even to filter dirty fluid that flows axially though the filter element 200.

FIG. 2A illustrates a side perspective view of the filter element of FIG. 1 and FIG. 2B illustrating a cross-sectional side view of the filter element of FIG. 1. As discussed above, the filter element 200 comprises a tubular ring of filter media 202 that has an open end cap 206 located at a first end 207 of the tubular ring of filter media 202 and a closed end cap 208 located at a second end 209 of the tubular ring of filter media 202.

As illustrated in FIG. 2A, the filter element 200 has a length 210 that is the distance between the outermost portion of the open end cap 206 and the outermost portion of the closed end cap 208. As also illustrated in FIG. 2A, the filter element 200 also includes a width 211 that is defined in the illustrated embodiment by the outside diameter of the open end cap 206 and the closed end cap 208. The opening 212 in the open end cap 206 of the filter element 200 illustrated in FIG. 2A also includes a width 214 defined by the outside diameter of the opening 212 of the open end cap 206. The open end cap 206 also includes a O-ring gasket 220 positioned on the exterior surface of the stem portion 218 of the open end cap 206.

As will be understood, embodiments of the filter element 200 disclosed by the present disclosure can have any length 210 or width 211 desired by a user. Likewise, different embodiments of the filter element 200 governed by the principles of the present disclosure can also have an opening 212 in the open end cap 206 having any width 214 desired by a user.

According to one aspect of the present disclosure, the length 210 of the filter element 200 can be between 5.0 inches and 40 inches. According to another aspect of the present disclosure, the diameter 211 of the filter element 200 can be between 1.0 inch and 8.0 inches. According to still yet another aspect of the present disclosure, the opening 212 in the open end cap 206 can have a diameter between 0.25 inches and 7.0 inches.

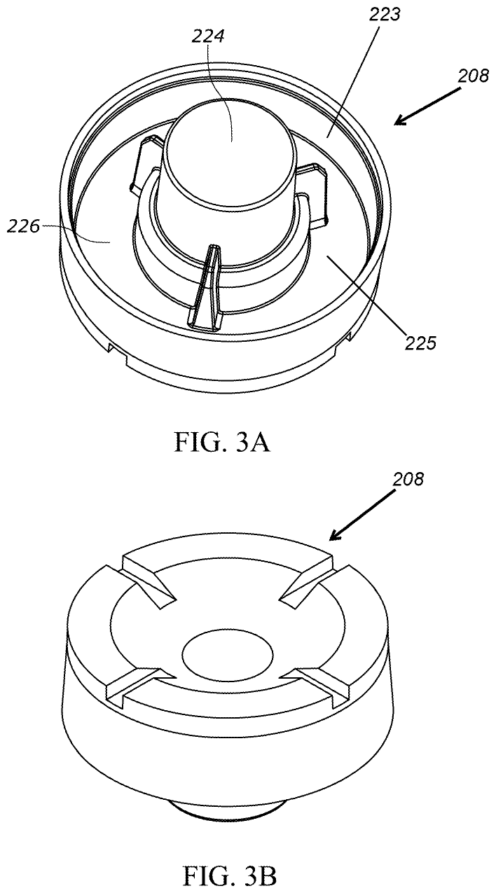

Next, with reference to FIGS. 3A and 3B illustrating a bottom perspective view and a top perspective view of the closed end cap 208 of the filter element 200. As illustrated, the closed end cap 208 has a sidewall 223 and a projection 224 that extends from a base 225 of the closed end cap 208. The sidewall 223, projection, and base 225 of the closed end cap 208 form a well 226.

As is best illustrated in FIG. 2B, the second end 209 of the tubular ring of filter media 202 is positioned within the well 226 of the closed end cap 208 while the projection 224 extends into the internal cavity 227 of the tubular ring of filter media 202.

According to one aspect of the present disclosure, when assembling the filter element 200 a first end 228 of the tubular ring of filter media 202 can be positioned within the well 226 of the closed end cap 208. A waterproof seal can then be formed between the first end 228 of the tubular ring of filter media 202 and the well 226 of the closed end cap 208 by any means generally known in the art such as, but not limited to, using any type of glue, resin, or epoxy to adhere the first end 228 of the tubular ring of filter media 202 to the well 226 of the closed end cap 208.

As will be understood, the waterproof seal formed between the first end 228 of the tubular ring of filter media 202 and the well 226 of the closed end cap 208 will ensure that no dirty fluid will enter the internal cavity 227 of the filter element 200 between the tubular ring of filter media 202 and the closed end cap 208, which would contaminate the fluid that has already been filtered by passing through the filter media 202 on the way to reaching the internal cavity 227 of the filter element 200.

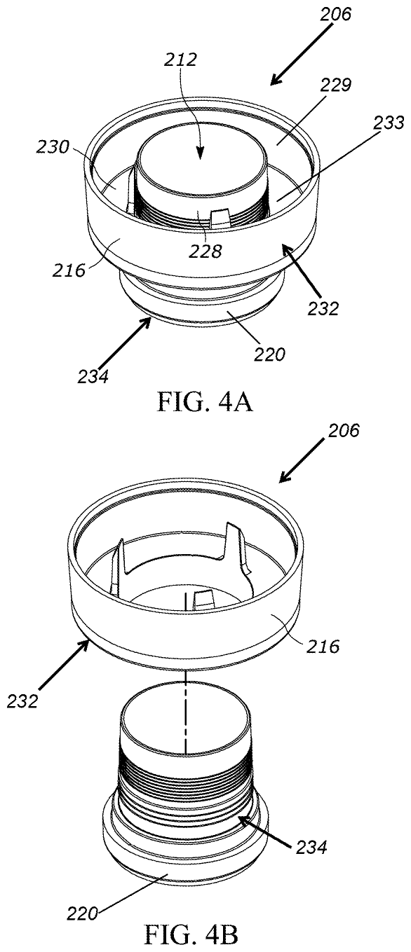

FIGS. 4A and 4B show a first top perspective view of an open end cap 206 and a second top perspective view of an open end cap 206 according to one aspect of the present disclosure. As illustrated, the open end cap 206 includes a collar portion 232 and a stem portion 234.

As will be understood, when the filter element 200 is mounted within the filter vessel 102 the O-ring gasket 220 of the open end cap 206 will make contact with and compress against at least a portion of the partition 114. When the O-ring gasket 220 compresses against the portion of the partition 114 the O-ring gasket 220 will form a watertight seal between the open end cap 208 of the filter element 200 and the partition 114 of the filter vessel 102.

As will be appreciated, the seal formed between the O-ring gasket 220 of the filter element 200 and the partition 114 of the filter vessel 102 ensures that all of the fluid that enters the filtered fluid plenum 117 has passed through the filter media 202 of the filter element 200 where the contaminants to be filtered by the tubular ring of filter media 202 are removed by the tubular ring of filter media 202.

As further illustrated, the open end cap 206 also includes a sidewall 229 that extends from a base 233 of the collar portion 232 of the open end cap 206 that is removably couplable to the stem portion 234 of the open end cap 206. As best illustrated in FIG. 4A when the collar portion 232 and the stem portion 234 of the open end cap 206 are assembled the sidewall 229 and the base 233 of the collar portion 232 and the stem portion 234 create a well 230 within the open end cap 208.

As will also be understood, the end caps 206 and 208 governed by the principles of the present disclosure can be any shape, size, or number of components required to fit within a specific filter vessel 102 being used by a user.

With reference to FIG. 2B, as the illustrated embodiment of the filter element 200 a second end 235 of the tubular ring of filter media 202 can be positioned within the well 230 of the open end cap 206. A waterproof seal can then be formed between the second end 235 of the tubular ring of filter media 202 and the well 230 of the open end cap 206 by any means generally known in the art such as, but not limited to, using any type of glue, resin, or epoxy to adhere the second end 235 of the tubular ring of filter media 202 to the well 230 of the open end cap 206.

As will be understood, the waterproof seal formed between the second end 235 of the tubular ring of filter media 202 and the well 230 of the open end cap 206 will ensure that no dirty fluid will enter the internal cavity 227 of the filter element 200 between the tubular ring of filter media 202 and the open end cap 206, which would contaminate the fluid that has already been filtered by passing through the filter media 202 on the way to reaching the internal cavity 227 of the filter element 200.

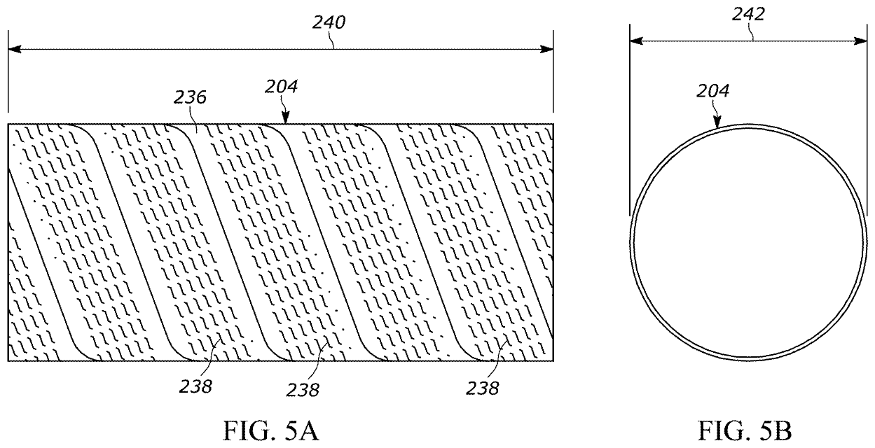

FIGS. 5A and 5B illustrate the support core 204 of the filter element 200 according to one aspect of the present disclosure. The support core 204 has a body 236 that can be made of any material generally known in the art, such as, but not limited to any plastic or metal material generally known in the art.

As also illustrated, the support core 204 includes openings 238 within the body 236 of the support core 204 to allow fluid flow through the support core 204. As will be understood, the size and shape of the openings 238 within the body of the support core 204 can be any size and shape desired by the user.

In another aspect of the present disclosure, the support core 204 will have a length 240 between 2.5 inches and 40 inches and a diameter 242 between 0.25 inches and 7.0 inches.

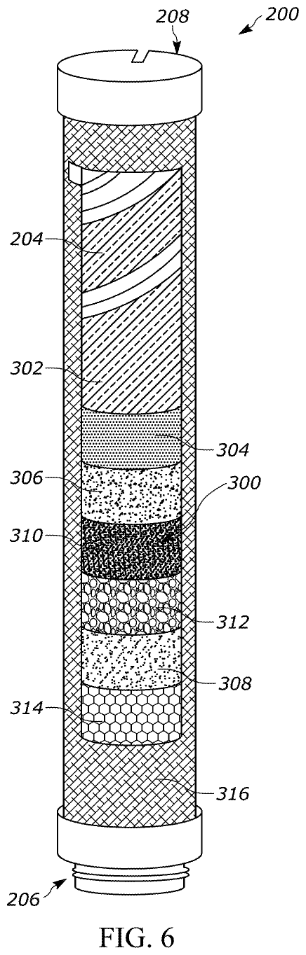

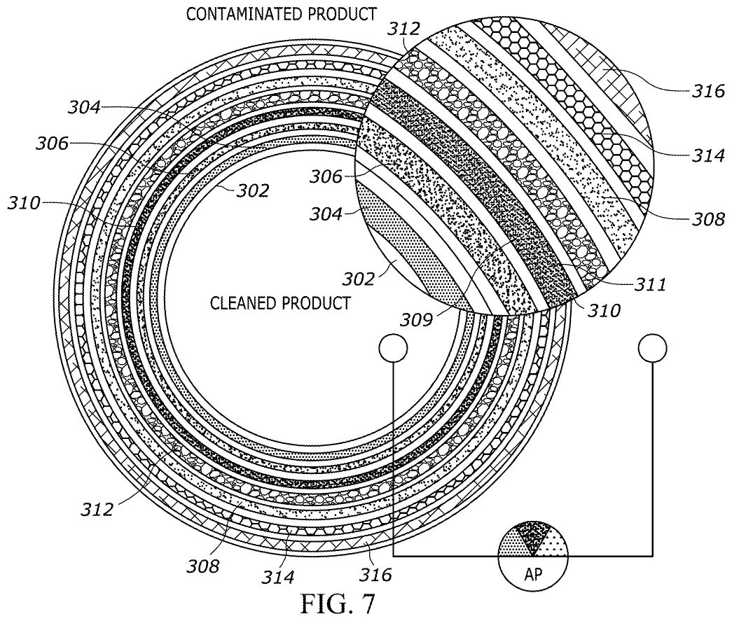

FIG. 6 illustrates a filter element 200 showing the layers of filter media 300 according to one aspect of the present disclosure and with additional reference to FIG. 7 illustrating the layers of filter media 300 according to another aspect of the present disclosure.

As illustrated, the filter media 300 has a carrier media layer 302 which is found throughout the filter media 300 because the other layers of the filter media 300 are supported by the carrier media layer 302. The carrier media layer 302 can be any type of carrier media generally known in the art, such as, but not limited to a 0.5 oz polyester scrim carrier. The next layer of the filter media 300 is a coarse filter media layer 304. As will be understood, the coarse filter media layer 304 can be composed of any coarse filter media generally known in the art, such as, but not limited to, a hydrophobic synthetic barrier.

As will be appreciated, the coarse filter media layer 304 helps to prevent the unwanted contamination of the fluid being filtered by the filter media 300 by preventing breakaway portions from the other layers of the filter media 300 from contaminating the fluid being filtered after the fluid has already been filtered through the various layers of the filter media 300.

The next innermost layer of the filter media 300 is a fine filtration media layer 306. As will be understood, the fine filtration media layer 306 can be made from any type of fine filtration media generally known in the art, such as, but not limited to, a fine filtration media that is made from micro-glass. The fine filtration media layer 306 can be made from any fibers having any size generally known in the art, such as, but not limited to having a fiber size of between 0.001 mm and 5 mm.

As will be appreciated, the fine filtration media layer 306 will be responsible for filtering the smaller contaminants that were too fine to be filtered from the fluid by the coarse filter media 312 located upstream from the fine filtration media layer 306. The next layer of the filter media 300 is a water-removing or water-capturing layer 310. The water-capturing layer 310 can be composed of any type of water-capturing media generally known in the art, such as, but not limited to any water-capturing media capable of removing free-water from a stream of hydrocarbon liquids.

The next layer of filter media 300 is the coarse filter media layer 312. The coarse filter media layer 312 can be composed of any coarse filtration media generally known in the art, such as, but not limited to, a hydrophobic synthetic screen. The coarse filter media layer 312 will act to filter out the larger contaminants or particulate matter that may be in the fluid being filtered. As will be understood, the smaller or finer contaminants or particulate matter will be filtered by the first fine filtration media layer 306 located downstream from the coarse filter media layer 312.

The next outermost layer of the filter media 300 is the outer wrap layer 308. As will be understood, the outer wrap layer 308 can be made from any material generally known in the art, such as, but not limited to a polyester material. According to one aspect of the present disclosure it is envisioned that the outer wrap layer 308 will be a 3 oz polyester wrap layer. The filter element 200 can also have a support screen 314 located outside of the outer wrap layer 308. The support screen 314 can be made of any material generally known in the art, such as, but not limited to, a plastic or a metal material.

As will be appreciated, the main role of the support screen 314 is to provide structural support to the other layers of the filter media 300. In particular, the support screen 314 acts to prevent the collapse or degradation of the other layers of the filter media 300 when the layers of the filter media 300 become wet from filtering fluid or are exposed to excessive pressure during the filtration process, such as the type of pressure that is common within a filter vessel 102 (see FIG. 1).

The filter element 200 illustrated in FIG. 6 also includes a sock 316 that forms the outermost layer of the filter media 300. The sock 316, can be made from any material generally known in the art, such as, but not limited to any type of synthetic material generally known in the art. As will also be understood, the sock 316 can have any form or characteristics generally known in the art, such as, but not limited to taking the form of a net or being made of a material that provides compression characteristics.

According to one aspect of the present disclosure the sock 316 will be formed separately from the remainder of the layers of the filter media 300 and the sock 316 will be positioned over the other layers of the filter media 300 only after the other layers of filter media 300 have been rolled into a tubular shape.

In another aspect of the present disclosure, the sock 316 will be wound with the other layers of the filter media 300, such that the sock 316 is not formed separately from the other layers of the filter media 300.

In yet another aspect of the present disclosure, a process for creating the water-capturing layer 310 of the filter media 300 disclosed herein will be discussed. According to one aspect of the present disclosure, the water-capturing layer 310 will use PEO 309 to complex any free-water in the fluid being filtered by hydrogen bonding the free-water in the fluid being filtered with the PEO 309 as the fluid passes through the water-capturing layer 310 of the filter media 300. The PEO 309 in the water-capturing layer 310 will be incorporated within a three-dimensional array of fibers or 3D fiber matrix 311. As illustrated, the PEO 309 in the water-capturing layer 310 will be chemically and physically bonded with the 3D fiber matrix 311 of the water-capturing layer, such that the PEO 309 in the water-capturing layer 310 will be prevented from migrating from the water-capturing layer 310 while fluid is filtered through the water-capturing layer 310 of the filter media 300.

As will be appreciated, and, as will be discussed in further detail below, the specific manufacturing process of the water-capturing media 310 results in the PEO 309 being chemically and physically bonded to the fibers of the 3D fiber matrix 311 in such a manner that the water-capturing layer 310 will be able to remove free-water from the fluid being filtered with the PEO 309 that is bonded to the fibers of the 3D matrix 311 while at the same time being permeable to the remaining portions of the fluid that is being filtered by the filter media 300 described herein.

In another aspect of the present disclosure, the water-capturing layer 310 will include a nonwoven fabric including short or staple fibers and long or continuous fibers that are bonded together. The short or staple fibers and the long or continuous fibers can be bound together by any means generally known in the art, such as, but not limited to, chemical bonding, mechanical bonding, heat treatment bonding, or solvent treatment bonding. Once bound together the staple fibers and the continuous fibers will form the 3D fiber matrix 311 of the water-capturing layer 310.

As will be understood, the short or staple fibers and the long or continuous fibers used in the nonwoven fabric that is formed into the 3D fiber matrix 311 can be any type or combination of fibers that are generally known in the art, such as, but not limited to acetate fibers, polyester fibers, or rayon fibers.

As will be understood, the short or staple fibers and the long or continuous fibers used in the nonwoven fabric that is formed into the 3D fiber matrix 311 can be fibers having any length or diameter generally known in the art.

According to another aspect of the present disclosure, the 3D fiber matrix 311 can include a support layer that will provide structural support to the bound-together short or staple fibers and the long or continuous fibers that are part of the 3D fiber matrix 311. The bound-together short or staple and long or continuous fibers can be attached to the support layer using any means generally known in the art such as, but not limited to, needling the fibers to the support layer.

Next, after forming the 3D fiber matrix 311 a powdered PEO 309 is applied to the 3D fiber matrix 311. As will be understood, it is envisioned that the PEO 309 may be applied to the 3D fiber matrix using any techniques generally known in the art, such as, but not limited to spreading a powdered PEO 309 over the surface of the 3D fiber matrix 311.

After the powdered PEO 309 has been applied to the 3D fiber matrix 311 the PEO 309 and 3D fiber matrix 311 are physically and chemically bonded together using a sintering process. During the sintering process the PEO 309 and 3D fiber matrix 311 are exposed to heat and/or pressure, which causes the chemical and physical bonding of the PEO 309 to the 3D fiber matrix 311.

As will be understood, the temperature that the PEO 309 and the 3D fiber matrix 311 will need to be exposed to during the sintering process in order for the PEO 309 to chemically and physically bond with the 3D fiber matrix 311 will depend on a variety of different factors, such as, but not limited to the fibers used to form the 3D fiber matrix 311, any chemicals applied to the fibers during the manufacturing of the 3D fiber matrix 311, the type of bonding used to bond together the fibers of the 3D fiber matrix 311, the thickness of the 3D fiber matrix 311, the density of the fibers in the 3D fiber matrix 311, and the amount of PEO 309 applied to the 3D fiber matrix 311.

According to one aspect of the present disclosure, the powdered PEO 309 and the 3D fiber matrix 311 will be exposed to temperatures between 100° F. and 450° F. during the sintering process.

According to another aspect of the present disclosure, the powdered PEO 309 and the 3D fiber matrix 311 will be exposed to temperatures between 180° F. and 330° F. during the sintering process.

As will also be understood, the pressure that the PEO 309 and the 3D fiber matrix 311 will need to be exposed to during the sintering process in order for the PEO 309 to chemically and physically bond with the 3D fiber matrix 311 will vary depending on a number of different factors, such as, but not limited to, the type of fibers used to form the 3D fiber matrix 311, any chemicals applied to the fibers during the manufacturing of the 3D fiber matrix 311, the type of bonding used to bond together the fibers of the 3D fiber matrix 311, the thickness of the 3D fiber matrix 311, the density of the fibers in the 3D fiber matrix 311, and the amount of PEO 309 applied to the 3D fiber matrix 311.

According to one aspect of the present disclosure, the powdered PEO 309 and the 3D fiber matrix 311 will be exposed to pressures between 50 psi and 250 psi during the sintering process.

According to another aspect of the present disclosure, the powdered PEO 309 and the 3D fiber matrix 311 will be exposed to pressures between 80 psi and 100 psi during the sintering process.

As will also be understood, the amount of time that the PEO 309 and the 3D fiber matrix 311 will need to be exposed to the heat and/or pressure during the sintering process in order for the PEO 309 to chemically and physically bond with the 3D fiber matrix 311 will vary depending on a number of different factors, such as, but not limited to, the temperature of the heat used during the sintering process, the amount of pressure used during the sintering process, the type of fibers used to form the 3D fiber matrix 311, any chemicals applied to the fibers during the manufacturing of the 3D fiber matrix 311, the type of bonding used to bond together the fibers of the 3D fiber matrix 311, the thickness of the 3D fiber matrix 311, the density of the fibers in the 3D fiber matrix 311, and the amount of PEO 309 applied to the 3D fiber matrix 311.

As will be understood, it is the sintering process between the powdered PEO 309 and the 3D fiber matrix 311 that forms the water-capturing media 310 that is used in the novel filter media 300 and filter element 200 described herein.

As will also be appreciated, the sintering process between the PEO 309 and the 3D fiber matrix 311 disclosed herein prevents the PEO 309 from being able to migrate from the water-capturing layer 310 as fluid is filtered through the filter media 300 disclosed herein. Thus, the water-capturing media layer 310 described herein allows for the filter media 300 and filter elements 200 using said filter media 300 to continue using PEO 309 as a means to remove free-water from a fluid stream while also not having to worry about the PEO 309 migrating from the filter media 310 and contaminating the fluid being filtered by said filter media 300.

According to another aspect of the present disclosure, the three-dimensional array of fibers or 3D fiber matrix 311 will be made of one or more fibers with one being PEO 309.

As will also be appreciated, any filter element 200 that uses the filter media 300 disclosed herein will also have the benefit of including an automatic shut-off or monitor feature due to the characteristics of the PEO 309 that is used with the water-capturing layer 310 of the filter media 300, Namely, one of the characteristics of the PEO 309 used in the water media layer is that it will agglomerate into an impervious elastic substance once the PEO 309 has been saturated and can no longer capture any additional free-water from the fluid being filtered by the filter media 300 disclosed herein.

As will be understood, when the PEO agglomerates into the impervious elastic substance it will turn the water-capturing layer 310 of the filter media 300 into a barrier for the fluid being filtered through the filter media 300, which will prevent any further fluid to flow through the filter element 200, thus indicating to the user that the filter element 200 is spent and needs to be replaced.

As will also be understood, even though the PEO particles 309 of the water-capturing media layer 310 discussed above are physically and chemically bonded with the 3D fiber matrix 311 the PEO 309 of the water-capturing media layer 310 will still agglomerate when the PEO particles 309 have has reached their free-water saturation point.

In other words, when the PEO particles 309 of the water-capturing layer 310 have become fully saturated and are no longer capable of removing any more free-water from the fluid being filtered the PEO particles 309 in the water-capturing media layer 310 will agglomerate, and turn the water-capturing media layer 310 into an impervious elastic substance. As will be understood, once the water-capturing media layer 310 is turned into the impervious elastic substance by the saturated PEO particles 309 the fluid being filtered will not be able to flow through the filter media 300.

As such, any filter element 200 including the filter media 300 disclosed herein will have the additional benefit of including a monitor or automatic shut off feature built into the filter media 300, which will both indicate to the user that the filter element 200 is spent because it is no longer removing free-water from the fluid being filtered and also prevent a user from continuing to use a filter element 200 that is spent, which would result in the filter being used past the point where it is able to remove free-water from the fluid being filtered, which could be dangerous in certain situations, such as when the fluid being filtered is jet fuel being pumped into an aircraft.

As will also be appreciated, if a user is using more than one filter element 200, such as in a filter vessel 102 designed to use multiple filter elements 300, the monitor or automatic shut-off feature also provides the additional benefit of being able to continue to use the other of the multiple filter elements 200 being used even if one of the filter elements 200 is spent and can no longer remove any free-water from the fluid being filtered because the monitor or automatic shut-off feature of the spent filter element 200 will prevent any further fluid flow through that spent filter element 200, but it will not prevent the fluid being filtered from continuing to flow through and be filtered by any unspent filter elements 200 that are also being used in the system.

As will be appreciated, the monitor or automatic shut-off feature provides the benefits of not having to prematurely change a filter element 200 to ensure that it is effective at removing free-water from the fluid being filtered because the filter media 300 of the filter element 200 described herein will automatically prevent additional fluid flow through the filter element 200 as a way to inform a user that the filter element 200 is spent and needs to be replaced.

As will also be appreciated, this also provides the benefit of not having to immediately change out a spent filter element 200 because fluid will not be able to flow through the spent filter element 200. As such, a user can wait until all of the filter elements 200 are spent before changing all of the filter elements 200 used in the system at the same time, which saves the user both time and costs.

In other words, the filter media 300 disclosed herein provides all of the benefits of previous SAP filter media without the substantial downside of contaminating the fluid which the free-water is being removed due to the filter material used to remove said free-water from the fluid,

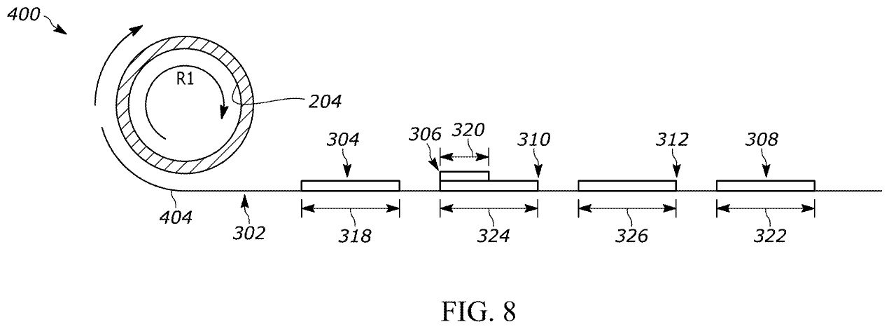

FIG. 8 illustrates one method of manufacturing the filter element 200 according to one aspect of the present disclosure. As illustrated, the filter manufacturing apparatus 400 includes a winder 402 and a conveyor belt 404. The winder 402 will have a sufficient shape and size such that the support core 204 of the filter element 200 can be inserted over the winder 402. The conveyor belt 404 can be any size and shape sufficient to allow for the different layers of filter media 300 to be wound in the appropriate order around the support core 204 when the winder 402 is rotated in direction R1.

As illustrated, the carrier media 302 is used as a base or support layer for the other layers of filter media 300.

According to one aspect of the present disclosure, it is envisioned that the coarse filter media layer 304 will have a length 318 of between 2.0 and 15 inches, that the fine filtration media layer 306 will have a length 320 between 1.0 and 15 inches, that the water-capturing media layer 310 will have a length 324 between 2.0 and 22.5 inches, that the coarse filter media layer 312 will have a length 326 between 2.0 inches and 18 inches, and the polyester wrap layer will have a length 322 between 3.0 and 15 inches.

According to one aspect of the present disclosure, it is envisioned that the layers of the filter media 300 described herein can have any length or width needed by a specific user or required to filter any specific contaminant from a fluid to be filtered by the filter media 300 or a filter element 200 using the filter media 300 described herein.

According to another aspect of the present disclosure, it is envisioned that the layers of the filter media 300 described herein can be rearranged in any order needed by a specific user or as required to filter a specific contaminant from a fluid to be filtered by the filter media 300 or a filter element 200 using the filter media 300 described herein.

According to still yet another aspect of the present disclosure, it is envisioned that that one or more of the layers of the filter media 300 may be removed or substituted with a different layer of filter media 300 as required by a specific user or as required to filter a specific contaminant from a fluid to be filtered by the filter media 300 or a filter element 200 using the filter media 300 described herein.

According to still yet another aspect of the present disclosure, it is envisioned that any of the layers of filter media 300 disclosed herein may be chemically treated with any materials generally known in the art to enhance or provide properties beneficial to the filtration process.

According to one aspect of the present disclosure it is envisioned that the layers of filter media 300 may be treated with materials such as, but not limited to, hydrophobic materials, hydrophilic materials, oleophobic materials, or oleophilic materials.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

It is understood that the preceding is merely a detailed description of some examples and embodiments of the present disclosure, and that numerous changes to the disclosed embodiments may be made in accordance with the disclosure made herein without departing from the spirit or scope of the disclosure. The preceding description, therefore, is not meant to limit the scope of the disclosure, but to provide sufficient disclosure to allow one of ordinary skill in the art to practice the disclosure without undue burden.

It is further understood that the scope of the present disclosure fully encompasses other embodiments that may become obvious to those skilled in the art. Features illustrated or described as part of one embodiment can be used in another embodiment to yield a still further embodiment. Thus, it is intended that the present disclosure cover such modifications and variations as come within the scope of the appended claims and their equivalents. It is to be understood by one of ordinary skill in the art that the present discussion is a description of exemplary embodiments only, and is not intended as limiting the broader aspects of the present disclosure, which broader aspects are embodied in the exemplary constructions.

1. A filter element comprising:
a support core surrounded by a tubular ring of filter media, the tubular ring of filter media further comprising a first end and a second end;
wherein the first end of the tubular ring of filter media being coupled to a first end cap and the second end of the tubular ring of filter media being coupled to a second end cap positioned opposite to the first end cap; and
wherein the tubular ring of filter media further comprises a carrier media layer, a coarse filter media layer, a fine filtration media layer, a water-capturing media layer, and an outer wrap.

2. The filter element of claim 1, wherein the carrier media layer is a scrim carrier selected from the group consisting of nylon, polyester and other synthetic materials.

3. The filter element of claim 1, wherein the coarse filter media layer is a hydrophobic screen.

4. The filter element of claim 1, wherein the fine filtration media layer is composed of a nonwoven filter media.

5. The filter element of claim 1, wherein the outer wrap is selected from a group consisting of synthetic and organic materials.

6. The filter element of claim 1, wherein the water-capturing media layer is a polyethylene oxide chemically or physically bonded to a three-dimensional array of fibers.

7. The filter element of claim 1, wherein the first end cap is one of an open end cap and a closed end cap.

8. The filter element of claim 7, wherein the second end cap is one of a closed end cap and an open end cap.

9. The filter element of claim 1, further comprising monitoring means to indicate to the user that the filter element is no longer removing free water from the fluid being filtered.

10. The filter element of claim 7, wherein the open end cap of the first end cap further includes an O-ring gasket positioned on the exterior surface of a stem portion of the end cap.

11. The filter element of claim 8, wherein the open end cap of the second end cap further includes an O-ring gasket positioned on the exterior surface of a stem portion of the end cap.

12. The filter element of claim 1, wherein the filter element has a length between 5.0 and 40 inches.

13. The filter element of claim 1, wherein the filter element has a diameter between 1.0 and 8.0 inches.

14. The filter element of claim 7, wherein the opening in the open end cap has a diameter between 0.25 and 7.0 inches.

15. A filter assembly comprising:
a filter housing having a filter vessel, wherein the filter vessel includes an inlet and an outlet and a partition having at least one opening located therebetween; and
a filter element further comprising:
a support core surrounded by a tubular ring of filter media;
a first end of the tubular ring of filter media being coupled to a first end cap and a second end of the tubular ring of filter media being coupled to a second end cap positioned opposite to the first end cap, wherein the first end cap is couplable to the opening in the partition of the filter vessel; and
wherein the tubular ring of filter media further comprises a carrier media layer, a coarse filter media layer, a fine filtration media layer, a water-capturing media layer, and an outer wrap.

16. The filter element of claim 15, wherein the carrier media layer is a scrim carrier selected from the group consisting of nylon, polyester and other synthetic materials.

17. The filter element of claim 15, wherein the coarse filter media layer is a hydrophobic screen.

18. The filter element of claim 15, wherein the first fine filtration media layer is composed of a nonwoven filter media.

19. The filter element of claim 15, wherein the outer wrap is selected from the group consisting of synthetic and organic materials.

20. The filter element of claim 15, wherein the water-capturing media layer is a three-dimensional array of fibers having polyethylene oxide chemically or physically bound to the three-dimensional array of fibers.

21. The filter element of claim 15, wherein the water-capturing media layer prevents the migration of polyethylene oxide and contamination of the filter media.

22. The filter element of claim 15, wherein the first end cap is one of an open end cap and a closed end cap.

23. The filter element of claim 15, wherein the second end cap is one of a closed end cap and an open end cap.

24. The filter element of claim 22, wherein the open end cap of the first end cap further includes an O-ring gasket positioned on the exterior surface of a stem portion of the end cap.

25. The filter element of claim 23, wherein the open end cap of the second end cap further includes an O-ring gasket positioned on the exterior surface of a stem portion of the end cap.

26. The filter element of claim 15, wherein the filter element has a length between 5.0 and 40 inches.

27. The filter element of claim 15, wherein the filter element has a diameter between 1.0 and 8.0 inches.

28. The filter element of claim 15, wherein the opening in the open end cap has a diameter between 0.25 and 7.0 inches.

29. A method of making a layer of water-capturing filter media, the method comprising the steps of:
selecting a first fiber and a second fiber;
attaching the first fiber to the second fiber to form a three-dimensional fiber matrix;
applying a polyethylene oxide to the three-dimensional fiber matrix;
applying heat and pressure to the polyethylene oxide and the three-dimensional fiber matrix until the polyethylene oxide forms a physical or chemical bond to the three-dimensional fiber matrix.

30. The method of making a layer of water-capturing filter media of claim 29, wherein the first fiber or the second fiber selected to make the three-dimensional fiber matrix is one of an acetate fiber, a polyester fiber, a nylon fiber, or a rayon fiber.

31. The method of making a layer of water-capturing filter media of claim 29, wherein the polyethylene oxide applied to the three-dimensional fiber matrix is a powdered polyethylene oxide.

32. The method of making a layer of water-capturing filter media of claim 29, wherein the process of applying heat and pressure to the polyethylene oxide and the three-dimensional fiber matrix includes sintering the polyethylene oxide and the three-dimensional fiber matrix until the polyethylene oxide is physically or chemically bonded to the three-dimensional fiber matrix.

33. The method of making a layer of water-capturing filter media of claim 29, wherein the polyethylene oxide and the three-dimensional fiber matrix are heated to temperatures between 100° F. and 450° F. during the sintering.

34. The method of making a layer of water-capturing filter media of claim 29, wherein the polyethylene oxide agglomerates into an impervious elastic substance once the polyethylene oxide has been saturated and can no longer capture any additional free-water from the fluid being filtered by the filter media.
